(19) United States
(12) Patent Application Publication
(10) Pub. No.: US 2010/0152408 A1
(43) Pub. Date: Jun. 17, 2010

(54) MANUFACTURING METHOD OF BIODEGRADABLE WATER-BASED POLYESTER RESIN

(76) Inventors: Kyung Ho Lim, Yongin-si (KR); Joong Kun Oh, Yongin-si (KR)

Correspondence Address: THOMPSON HINE L.L.P.;Intellectual Property Group, P.O. BOX 8801, DAYTON, OH, 45401-8801, US

(21) Appl. No.: 12/519,184

(22) PCT Filed: Dec. 21, 2007
(86) PCT No.: PCT/KR2007/006760

§ 371 Date: Feb. 15, 2010

(30) Foreign Application Priority Data
Dec. 21, 2006 (KR) 10-2006-0132046

(51) Int. Cl. C08G 63/85; C08G 63/00

(52) U.S. Cl. 528/279

(57) ABSTRACT

The present invention relates to a method for preparing a biodegradable water soluble polyester resin, more specifically relates to a method for preparing a biodegradable water soluble polyester resin using a non-toxic catalyst. The method of the present invention uses a tri-component catalyst consisting of citric acid-Ti—Zn to accelerate a reaction velocity while avoiding use of a prior toxic catalyst.

### TECHNICAL FIELD

The present invention relates to a method for preparing a biodegradable water based polyester resin, more specifically relates to a method for preparing a biodegradable water soluble polyester resin using a non-toxic catalyst.

### BACKGROUND ART

A representative polyester resin that has been used as various applications such as fibers, molding articles, films and the like is a high molecular weight aromatic polyester resin produced by polycondensation reaction of terephthalic acid and ethylene glycol, or terephthalic acid and 1,4-butane diol, wherein the high molecular weight polyester refers to a polymer having a number average molecular weight of 10,000 or more. However, the aromatic polyester resin after disposal would not be degraded and remain for long period of time in the environment, and cause to serious environmental pollution problems.

An aliphatic polyester that was known as having biodegradable property (Journal of Macromol. SCI-Chem., A-23(3), 1986, 393-409) has been used in various applications. However, since existing aliphatic polyesters usually have a number average molecular weight of at most 15,000 and does not have sufficient physical properties, there is a problem regarding expansion of application range. Korean Patent Application Publication No. 1995-0000758, Korean Patent Application Publication No. 1995-0114171, Korean Patent Application Publication No. 1995-0025072, WO95/03347A1 and the like disclose methods for increasing a molecular weight of the aliphatic polyester, however problems of the aliphatic polyester regarding productivities, physical properties, molding properties and the like would not be solved and remain.

Accordingly, Korean Patent No. 366484 discloses a biodegradable polyester resin composition and a method for producing the same using an aromatic in place of an aliphatic. The method of the above-mentioned patent comprises a first step for introducing an aromatic dicarboxylic acid, an aliphatic dicarboxylic acid including an aliphatic succinic acid, and 1,4-butane diol or ethylene glycol and carrying out esterification or trans-esterification reaction to produce an aromatic/aliphatic low molecular weight high-molecular body having four or less repeating units of an aromatic component and a molecular weight of 300-30,000; a second step for introducing additionally an aliphatic dicarboxylic acid including succinic acid and 1,4-butane diol or ethylene glycol to an aromatic/aliphatic low molecular weight high-molecular body produced in the first step above to obtain polymer resin; and a third step for further carrying out polycondensation reaction of produced polymer resin to produce a copolyester resin composition having a number average molecular weight of 30,000 to 70,000, a weight average molecular weight of 100,000 to 600,000, a melting point of 55 to 120° C. and a melting index (190° C., 2,160 g) of 0.1 to 30 g/10 min, which has excellent molding properties and tear strength.

However, an article produced according to the method disclosed in the above-mentioned patent is a biodegradable resin and eco-friendly, but it should be used with an organic solvent on being used in a coating and the like, since it does not have water solubility.

Korean Patent Application Publication No. 10-2003-0028444 discloses a biodegradable polyester resin composition having a high number average molecular weight of 30,000 and water solubility. However, the water soluble biodegradable polyester resin produced in such a manner has a drawback in that a toxic catalyst such as antimony or tin is used during production of the polyester resin. According to the report of researchers of Heidelberg University in Germany (Journal of Environmental Monitoring, 2006, 8, 288-293), antimony was found in even water bottle produced with PET, which is commonly used in our daily life. Although WHO considers as safe in terms of standards of drinking water, a toxic antimony has been accumulated in human body. In particular, according to an article of media in 2004 in Korea, eight persons of 60 persons who dwell in a village of Yeonki-kun, Chungchungnamdo passed away with cancer for last five years, and 4 persons struggled against a disease. It was assumed that the cause is a pollution caused by an antimony factory constructed in the village at 1978. At that time, Green Korea United reported that content of antimony in surface water of a rice field is 90 μg/l and content of antimony in subterranean water of a farmhouse which is located closed to the antimony factory is 15.9 μg/l. According to antimony standards of water quality in foreign countries, content of antimony is 6 μg/l in America, 2 μg/l in Japan, 3 μg/l in Australia, 10 μg/l in France, and 5 μg/l or less in WHO.

Accordingly, there is persistent need of a water soluble biodegradable resin having high molecular weight even using a non-toxic catalyst.

### DISCLOSURE OF INVENTION

### Technical Problem

Accordingly, it is an object of the present invention to provide a method for preparing a non-toxic biodegradable polyester resin.

Another object of the present invention is to provide a non-toxic biodegradable polyester resin.

Another object of the present invention is to provide a non-toxic water soluble biodegradable polyester resin.

Another object of the present invention is to provide a method for preparing a non-toxic water soluble biodegradable polyester resin for coating.

### Technical Solution

To achieve the above objects, the present invention provides a method for preparing a non-toxic biodegradable water soluble polyester resin comprising a step of esterificating or trans-esterificating dicarboxylic acid mixtures, sulfonic acid alkali metal bases and aliphatic diols and then a step of polycondensating the resulting reaction product, wherein the method uses a tricomponent catalyst consisting of citric acid-Ti—Zn.

In the present invention, as the dicarboxylic acid mixtures, adipic acid, glutaric acid, sebasinic acid, anhydride succinic acid, succinic acid, dimethylsuccinate, dimetylglutarate, dimethyladipate, terephthalic acid, phthalic acid, isophthalic acid, dimethylterephthalate, dimethylisophthalate and the like can be used, and preferably the dicarboxylic acid is used as the mixtures with an aliphatic and an aromatic compound to render the resulting product to exhibit suitable biodegradable property.

In the present invention, the sulfonic acid alkali metal salts are used to provide water solubility to biodegradable resin, and preferable sulfonic acid alkali metal salts may be at least one selected from dimethyl-4-sulfoisophthalate sodium salt, dimethyl-5-sulfoisophthalate sodium salt, dimethyl-5-sulfoterephthalate sodium salt, diethyl-5-sulfoterephthalate sodium salt and the like.

In the present invention, the aliphatic diols may be at least one selected from ethylene glycol, propylene glycol, 1,3-propane diol, 1,2-butane diol, 1,3-butane diol, 1,4-butane diol, neopentyl glycol, 1,6-hexane diol, diethylene glycol, polyethylene glycol and the like, considering adhesive force to base resin to be coated or slipping property after completing coating process and drying process when the resulting product is used as coating agent.

In the present invention, the esterification reaction or the trans-esterification reaction may be carried out by well known generic esterificating or trans-esterificating process in the art, and there are no specific limitations as long as a catalyst such as antimony or tin and the like may be excluded.

In an embodiment of the present invention, the esterification reaction or the transesterification reaction is carried out after adding aliphatic and aromatic dicarboxylic acid mixtures of 45 to 55% by weight based on total mixtures, aliphatic diols of 30 to 42% by weight based on total mixtures and sulfonic acid alkali metal bases to provide water solubility of 3 to 20% by weight based on total mixtures.

In an embodiment of the present invention, a suitable temperature of the esterification reaction or the trans-esterification reaction is preferably approximately 200° C. Particularly, when the reaction temperature is 180° C. or less, a reaction velocity becomes slow, and when the reaction temperature is 220° C. or more, a polymerization reactant may be pyrolyzed. In an embodiment of the present invention, it is preferable to increase rapidly the reaction temperature to the suitable reaction temperature at an initial stage of the reaction for rapid dissolution of solid raw material and rapid reaction with liquid raw material. When the reaction temperature is increased slowly, much time is necessary to dissolve completely the solid raw material, and solid raw material that is not dissolved completely can not participate in the reaction. As a result, the resulting resin can not have isotactic molecular structure, and various physical properties including biodegradable property thereof become deteriorate.

In a preferable embodiment of the present invention, the esterification reaction or the trans-esterification reaction is preferably carried out by a first reaction of aromatic dicarboxylic acid and then a second reaction of aliphatic dicarboxylic acid, wherein each monomer are bonded isotactically, and accordingly the resulting resin has excellent biodegradable property. In this case, a preferable reaction temperature for the esterification reaction is 160 to 200° C., and a preferable reaction temperature of the trans-esterification reaction is 180 to 200° C.

In the present invention, the polycondensation reaction is carried out by using the reaction product of the esterification reaction or the trans-esterification reaction, and a tricomponent catalyst, i.e., citric acid-Ti—Zn. The catalysts may be introduced simultaneously or sequentially in the polycondensation reaction. In an embodiment of the present invention, the tricomponent catalyst may be consisted of one component introduced in the esterification reaction or trans-esterification reaction, and other components introduced in the polycondensation reaction. In a preferred embodiment of the present invention, the Ti and the citric acid are introduced in the esterification reaction or trans-esterification reaction, and the Zn is introduced in the polycondensation reaction.

When any a component of the tricomponent catalyst is not introduced, a reaction velocity of the polycondensation reaction becomes slow and a molecular weight of the resulting product dose not become 30,000.

In the present invention, the citric acid is a harmless material that is frequently used in food additives, and consists of three carboxylic groups and one hydroxyl group. When the citric acid is used in the tricomponent catalyst, a reaction velocity becomes fast and a resin having high molecular weight can be obtained, since monomers are molecularly bonded in four directions. In an embodiment of the present invention, when the citric acid is used in an excess amount, a gelling phenomenon accompanying with a crosslinking can occur. Accordingly, the preferable amount of the citric acid is 0.05 to 0.3% by weight.

In the present invention, Ti and Zn constituting the tricomponent catalyst can be provided in various forms, preferably a form of metal compound including Ti and Zn, more preferably a form of organometallic compound including Ti and Zn, and most preferably a form of tetrabutyl titanate or zinc acetate. In an embodiment of the present invention, a used amount of the Ti and the Zn based catalyst is 0.03 to 0.5% by weight respectively. When the amount is less than 0.03% by weight, a reaction velocity becomes slow, and when the amount is 0.5% by weight or more, a reaction velocity is fast, however a color of the resulting product of the polymerization becomes worse.

In the present invention, various additives such as stabilizers, coloring agents and the like in addition to polycondensation catalysts may be introduced after completion of the esterification reaction or the trans-esterification reaction. The polycondensation reaction is carried out at a reaction temperature of 230 to 250° C. under the reduced pressure.

There are no specific limitations regarding the stabilizers or coloring agents used in the polycondensation reaction. Any generic stabilizers or coloring agents that are used in production of polyester resin can be used. Specifically, a stabilizer or a mixed stabilizer of one or two compounds selected from trimethylphosphate, trimethylphosphine, triphenylphosphate and phosphate, and their addition amount is preferably 0.1 to 0.4% by weight respectively based on a total composition.

In an embodiment of the present invention, when the temperature of the polycondensation reaction is 230° C. or less, the polycondensation reaction becomes slow, and when the temperature is 250° C. or more, it is not possible to obtain high molecular polymerization product due to thermolysis of polymerization product. Further, high vacuum condition may be generated by reducing pressure during polycondensation reaction. However, when the pressure is 2 torr or more, it is difficult to obtain high molecular polymerization product since it is difficult to remove side product or oligomer, excess glycol and the like that are produced during the polycondensation reaction. A preferable pressure is 0.5 ton.

The polyester resin produced by the polymerization reaction mentioned above has a biodegradable property and exhibits water solubility due to ionization group included in a molecular chain. Moreover, it is possible to produce harmless water soluble biodegradable resin without releasing harmful material even when it is used as a coating agent, since antimony or tin and the like is excluded during the production process of the resin.

In an aspect, the present invention provides harmless water soluble biodegradable polyester resin without having antimony and tin, produced by the method mentioned above. The polyester resin of the present invention has a molecular weight of about 30,000 to 60,000, preferably 30,000 to 50,000, and most preferably about 30,000. When the molecular weight is excess of 60,000, a reaction period of time becomes long. Also, when a coupling agent is used to reduce a reaction period of time, it is not preferable due to its toxicity.

In an aspect, the present invention provides a coating agent using the harmless water soluble biodegradable polyester resin without having antimony and tin. The coating agent may be simply produced by dissolving the water soluble polyester resin according to the present invention in water.

### Advantageous Effects

The present invention can provide the harmless water soluble polyester resin. Also, the method for producing the polyester resin has high productivity, since the method can produce harmless resin simultaneously.

### Mode for the Invention

The present invention is described in detail through the following non-limiting examples. The examples are described not to limit the present invention but to illustrate the present invention.

### EXAMPLE

### Example 1

To 500 ml two-neck flask displaced with nitrogen were added 21% by weight of dimethylterephthalate, 18% by weight of dimethylisophthalate, 4% by weight of dimethyl-5-sulfoisophthalate, 6% by weight of ethylene glycol, 38% by weight of diethylene glycol and 0.1 part by weight of tetrabutyltitanate as catalyst. A transesterification reaction was carried out under nitrogen atmosphere while increasing temperature slowly and maintaining inner temperature to 200° C. or less. After completing outflow of byproduct methanol, 13% by weight of adipic acid was added. And then, 0.1 parts by weight of tetrabutyltitanate as catalyst, 0.1 parts by weight of citric acid, 0.1 parts by weight of triphenylphosphate as stabilizer and 0.1 parts by weight of cobalt acetate as coloring agent were added. An esterification reaction was carried out while maintaining inner temperature to 200° C. or less to flow out water theoretically. After completion of the esterification reaction, 0.1 parts by weight of zinc acetate as catalyst, 0.1 parts by weight of tetrabutyltitanate as catalyst and 0.1 parts by weight of triphenylphosphate as stabilizer were added to the reactor. Vacuum was created in the reactor slowly to make high vacuum of 0.5 torr while increasing a temperature of the reaction mixture to 240° C. Under the reaction conditions, polycondensation reaction was carried out 200 min. A number average molecular weight of the obtained product was determined. The determined data were shown in Table 1.

### Comparative Example 1

This example was carried out in the identical manner to the example 1 except that Zn and citric acid were not added. The reaction did not proceed and was terminated. The determined data were shown in Table 1.

### Comparative Example 2

This example was carried out in the identical manner to the example 1 except that citric acid was not added. After carrying out a reaction for 300 min, a molecular weight was determined. The determined data were shown in Table 1.

### Comparative Example 3

This example was carried out in the identical manner to the example 1 except that Zn was not added. After carrying out a reaction for 260 min, a molecular weight was determined. The determined data were shown in Table 1.

### Comparative Example 4

This example was carried out in the identical manner to the example 1 except that antimony and tin were used in place of citric acid and Zn. After carrying out a reaction for 180 min, a molecular weight was determined. The determined data were shown in Table 1.

TABLE 1

| | Tin | Sb | Ti | Zn | Citric acid | Reaction time | Mn |
|---|---|---|---|---|---|---|---|
| Ex. 1 | — | — | 0.3 | 0.1 | 0.1 | 200 min | About |
| | | | | | | | 30,000 |
| Comp. | — | — | 0.3 | — | — | No reaction | — |
| Ex. 1 | | | | | | | |
| Comp. | — | — | 0.3 | 0.1 | — | 300 min | About |
| Ex. 2 | | | | | | | 15,000 |
| Comp. | — | — | 0.3 | — | 0.1 | 260 min | About |
| Ex. 3 | | | | | | | 10,000 |
| Comp. | 0.1 | 0.1 | 0.3 | — | — | 180 min | About |
| Ex. 4 | | | | | | | 30,000 |

As described above, the catalyst system of the present invention exhibited identical level of reaction time and molecular weight without using harmful catalyst, i.e., antimony or tin-based catalyst. Adversely, when two kinds of catalyst were not simply used, a reaction did not occur at all like the comparative example 1. Also, when any component of the citric acid and Zn were not used, reaction time become slow and increasing of molecular weight did not occur.

Performance Test of Coating Agent

Water solubility, applying property and slipping property of the polyester produced in the example 1 were determined. First of all, as an experiment to evaluate water solubility, 10 g of synthesized resin was introduced in 100 g of water with maintaining a temperature to 80° C., and stir it and determine a time that the resin was completely dissolved. When the resin was dissolved in water completely and an aqueous solution was produced, the aqueous solution was coated on a surface of the polylactic acid(PLA) sheet with bar coater (10 μm) to determine applying property(coating property) against a biodegradable resin. In this time, whether the aqueous solution forms a drop of water or not was observed. After drying process, coated surfaces were put opposite each other and maintained for 24 hours under 10 kg load. Thereafter, slipping property was determined by evaluating whether coated surfaces of a sheet were adhered each other or not. Also, for evaluating an adhesive force of anti-fogging layer, a scotch tape was stick in 90° direction to a surface of a sheet coated with anti-fogging liquid and released with a velocity of 200 mm/min, and release conditions of the anti-fogging agent was observed. The aqueous resin solution of the present invention was coated on a disposable food packaging container, and anti-fogging property was observed. For evaluating anti-fogging property, two kinds of aqueous resin solution, i.e., a coating solution immediately after production and a coating solution after storage for 15 days, were used. The two coating solutions were coated on a surface of PLA sheet. And then, water of 80° C. was introduced into a container, and the coated PLA sheets were disposed on the container. Under the condition mentioned above, high temperature anti-fogging property was observed. Low temperature anti-fogging property was observed with water of 30° C. under cold storage. The test results were shown in Table 2 and Table 3.

### Example 2

A polyester resin was produced according to content described in Table 2 and the method of the example 1. Test results were shown in Table 2 and Table 3.

### Example 3

A polyester resin was produced according to content described in Table 2 and the method of the example 1. Test results were shown in Table 2 and Table 3.

### Example 4

A polyester resin was produced according to content described in Table 2 and the method of the example 1. Test results were shown in Table 2 and Table 3.

### Example 5

A polyester resin was produced according to content described in Table 2 and the method of the example 1. Test results were shown in Table 2 and Table 3.

### Example 6

A polyester resin was produced according to content described in Table 2 and the method of the example 1. Test results were shown in Table 2 and Table 3.

### Comparative Example 1

A polyester resin was produced according to content described in Table 1 and the method of the example 1, except that dimethyl sulfonic acid was not used. Test results were shown in Table 2 and Table 3.

### Comparative Example 2

A polyester resin was produced according to content described in Table 1 and the method of the example 1, except that butane diol was used in place of diethylene glycol. Test results were shown in Table 2 and Table 3.

TABLE 2

| | | | | Sulfonic | | | | | | |
|---|---|---|---|---|---|---|---|---|---|---|
| | Dicarboxylic | | | acid | | | | | | |
| | acid (%) | | | base(%) | Glycol | | | Applying | Slipping | Dissolving |
| | DMT | DMI | AA | DMS | EG | DEG | BD | property | property | power |
| Ex. 1 | 21 | 18 | 13 | 4 | 6 | 38 | — | ⊚ | X | 28 min |
| Ex. 2 | 20 | 17 | 14 | 6 | 10 | 33 | — | ⊚ | X | 20 min |
| Ex. 3 | 19 | 17 | 14 | 9 | 14 | 27 | — | ⊚ | X | 14 min |
| Ex. 4 | 22 | 19 | 9 | 12 | 18 | 20 | — | ◯ | Δ | 13 min |
| Ex. 5 | 22 | 19 | 9 | 14 | 22 | 14 | — | ◯ | ◯ | 12 min |
| Ex. 6 | 20 | 18 | 10 | 19 | 26 | 7 | — | ◯ | ◯ | 10 min |
| Comp. | 24 | 24 | 16 | — | 29 | 7 | — | Δ | ◯ | X |
| Ex. 1 | | | | | | | | | | |
| Comp. | 19 | 18 | 14 | 12 | 15 | — | 22 | X | ⊚ | 16 min |
| Ex. 2 | | | | | | | | | | |

DMT: Dimethylterephthalate
DMI: Dimethylisophthalate
AA: Adipic acid
DMS: Dimethyl-5-sulfoterephthalate
EG: Ethylene glycol
DEG: Diethylene glycol
BD: 1,4-butane diol
<Applying property>
⊚: aqueous solution did not form a drop of water and evenly spreading condition thereof was excellent
◯: aqueous solution did not form a drop of water and evenly spreading condition thereof was good
Δ: aqueous solution did not form a drop of water and evenly spreading condition thereof was fair
X: aqueous solution formed a drop of water and could not evenly spread
<Slipping property>
⊚: stacked two surfaces were released very readily
◯: stacked two surfaces were not adhered and were released easily
Δ: there was a little adhesive force between stacked two surfaces
X: stacked two surfaces were adhered

The test results which are shown in the Table 2 exhibit applying property, slipping property and dissolving power of examples and comparative examples. The applying property is to determine coating property against biodegradable resin under the condition that resins are dissolved in water completely. The slipping property is to determine a degree of adherence between coated surfaces of applied sheet. The dissolving power is to determine time necessary to be dissolved in water.

The table 3 exhibits a condition of anti-fogging layer immediately after production and after storage for 15 days, and also exhibits an anti-fogging property immediately after production and after storage for 1 month.

TABLE 3

| | Adhering force of | | | |
|---|---|---|---|---|
| | anti-fogging layer | | Anti-fogging property | |
| | Immediately | | Immediately | |
| | after | After storage | after | After storage |
| | production | for 15 days | production | for 1 month |
| Ex. 1 | Good | Good | Bad | Bad |
| Ex. 2 | Good | Good | Fair | Bad |
| Ex. 3 | Good | Good | Good | Fair |
| Ex. 4 | Good | Good | Good | Fair |
| Ex. 5 | Good | Good | Good | Good |
| Ex. 6 | Fair | Fair | Good | Good |
| Comp. | Fair | Bad | Non | Non |
| Ex. 1 | | | | |
| Comp. | Bad | Bad | Fair | Bad |
| Ex. 2 | | | | |

<Adhering force>
Good: anti-fogging layer was not released
Bad: anti-fogging layer was released
<Anti-fogging property>
Good: anti-fogging layer was wetted uniformly and a drop of water was not formed
Fair: drops of water were formed partly on anti-fogging layer
Bad: drops of water were formed generally on anti-fogging layer and become fogging.

Toxic test results of the synthesized resin carried out by Korea Chemical Test Institute were shown in Table 4.

TABLE 4

| Test item | Unit | Result |
|---|---|---|
| Pb | mg/kg | Not detected |
| Cd | mg/kg | Not detected |
| Cu | mg/kg | Not detected |
| Cr | mg/kg | Not detected |
| Ni | mg/kg | Not detected |
| Zn | mg/kg | 110 |
| Hg | mg/kg | Not detected |
| As | mg/kg | Not detected |
| C | wt % | 82.7 |
| AP content | wt % | 99.9 |

The table 4 exhibits the test results which were determined in Korea Testing and Research Institute for Chemical Industry (KTRI), and a toxic test of KTRI was carried out by ICP analysis. As described above, any antimony or tin based compounds which were commonly used in a production process of polyester as well as other heavy metals were not detected. As shown in the test results, prior various coating agents of food containers which were used in these days could be replaced with a non-toxic water soluble biodegradable resin of the present invention. As an example, when the non-toxic water soluble biodegradable resin of the present invention is used as an anti-fogging coating agent of a transparent food container, the resin can be used in place of prior surfactant based anti-fogging agent, and exhibits excellent performance in terms of anti-fogging durability. In this time, AP content means a degree of dissolution in chloroform.

1. A method for preparing a non-toxic biodegradable water soluble polyester resin, comprising a step of esterificating or trans-esterificating dicarboxylic acid mixtures, sulfonic acid alkali metal bases and aliphatic diols, and a step of polycondensating the resulting reaction product, characterized in that the method uses a tricomponent catalyst consisting of citric acid-Ti—Zn.

2. The method of claim 1, characterized in that the Ti and the citric acid are introduced in the esterification reaction or the trans-esterification reaction, and the Zn is introduced in the polycondensation reaction.

3. The method of claim 1, characterized in that each component of the catalyst uses in the range of 0.03 to 0.5% by weight.

4. The method of claim 1, characterized in that the Ti and the Zn are introduced as an organometallic compound.

5. The method of claim 1, characterized in that the esterification reaction and the trans-esterification reaction are carried out at a temperature of 160 to 200° C. and the polycondensation reaction is carried out at a temperature of 230 to 250° C.

6. Antimony free water soluble biodegradable polyester resin having a molecular weight of about 30,000 to 60,000.

7. A coating agent in which antimony free water soluble biodegradable polyester resin of claim 6 is dissolved.
